(19) United States
(12) Patent Application Publication
(10) Pub. No.: US 2012/0170107 A1
(43) Pub. Date: Jul. 5, 2012

(54) ELECTRONIC PAPER DISPLAY AND METHOD FOR MANUFATURING THE SAME

(75) Inventors: Sang Jin KIM, Gyeonggi-do (KR); Choong Hee Lee, Gyeonggi-ldo (KR); Jung Min Park, Gyeonggi-do (KR); Hwan Soo Lee, Seoul (KR)

(73) Assignee: SAMSUNG ELECTRO-MECHANICS CO., LTD., Suwon (KR)

(21) Appl. No.: 13/340,207

(22) Filed: Dec. 29, 2011

(30) Foreign Application Priority Data
Jan. 4, 2011 (KR) 10-2011-0000678

(51) Int. Cl. G02F 1/167; H01R 43/00

(52) U.S. Cl. 359/296; 29/825

(57) ABSTRACT

Disclosed herein are an electronic paper display and a method for manufacturing the same. In the electronic paper display according to the present invention, red, green, blue, and black (RGBK) rotatable balls are included in a plurality of pixel spaces isolated by barrier ribs, two or more rotatable balls having the same color are connected to one thin film transistor (TFT), and the thin film transistors (TFTs) for respectively realizing red, green, blue, and black (RGBK) colors constitute one unit pixel. According to the present invention, when the rotatable balls exhibiting each of the RGBK colors are connected in two or more and simultaneously driven within one unit pixel, the pixel electrodes are made to be large and connected to one TFT. As a result, the number of TFTs can be decreased even though a large-area display is manufactured, and the volume of module can be minimized.

### CROSS REFERENCE(S) TO RELATED APPLICATIONS

This application claims the benefit under 35 U.S.C. Section 119 of Korean Patent Application Serial No. 10-2011-0000678, entitled “Electronic Paper Display and Method for Manufacturing the same” filed on Jan. 4, 2011, which is hereby incorporated by reference in its entirety into this application.

### BACKGROUND OF THE INVENTION

1. Technical Field

The present invention relates to an electronic paper display and a method for manufacturing the same, and more particularly, to a large area electronic paper display capable of displaying various colors and a method for manufacturing the same.

2. Description of the Related Art

A digital paper display is emerging as a next generation display device following a liquid crystal display (LCD), a plasma display panel (PDP), and an electro luminescence display (EL), and is being steadily and continuously studied.

Especially, electronic paper is a display device capable of displaying characters and images by using a flexible substrate, such as thin film type plastics, in which millions of balls (rotatable balls) are scattered in oil holes. Since electronic paper can be reused several million times, it is being noticed as materials that can substitute for the existing printed media such as books, newspapers, magazines, or the like.

The rotatable ball has a size of about 5 to 200 μm, and hemispheres respectively exhibiting black and white are respectively made of materials exhibiting negative charges and positive charges. As such, the whole rotatable ball is one electric dipole, and thus, has a dipole moment in an electric field.

As for color realization using the rotatable balls, in a structure having barrier ribs, which enable the rotatable balls to be freely rotatable, when electric rotation is applied to the rotatable balls each positively (+) charged and negatively (−) charged half and half, by controlling the direction of voltage, black/white may be exhibited, or red, blue, and green colors may be exhibited.

Here, an active mode type is employed for driving of balls. In other words, one ball per TFT is driven in this type. The following table 1 shows the number of balls and the number of TFTs needed according to the size of pixel. When the ball has a size of 100 μm, 520,000 balls for a 6-inch display, 1,300,000 balls for a 10-inch display, and 7,000,000 balls for a 22-inch display are needed, and thus, the same number of TFTs are needed. When the size of the ball is decreased to 70 μm, considering voltage, about 15,000,000 TFTs are needed for the 22-inch display. In a case of a large-area digital information display (DID), the number of balls and the number of TFTs needed are difficult to calculate.

TABLE 1

| | |
|---|---|
| | the number of balls and |
| pixel size | the number of TFTs |

| (inch) | 70 μm ball | 100 μm ball |
|---|---|---|
| 6 inches | 1,158,774 | 515,010 |
| 10 inches | 2,920,155 | 1,297,846 |
| 22 inches | 14,790,000 | 6,573,333 |
| DID large inches | ? | ? |

On the other hand, an electronic paper display using rotatable balls according to the related art has a structure as shown in FIG. 1, in order to exhibit red/green/blue (RGB) colors, and arrangement configuration thereof is as shown in FIG. 2.

In a structure where a pixel space area is formed and a plurality of barrier ribs 10 isolating cells are formed in the pixel space area, red, green, blue, and black (RGBK) rotatable balls 20 for color realization are included in each unit cell within the pixel space area. The four RGBK colors are needed in constituting one unit pixel. Pixel electrodes 30 are formed correspondingly to each color for realization of four colors, and thin film transistors (TFTs) 40 are connected to the pixel electrodes 30 respectively. In the above structure, four thin film transistors (TFTs) are needed for realization of four colors.

In a case of a display having a small size, such as 10 inches or less, even though the above arrangement configuration is employed in the display, TFT modules and parts can be supplied.

However, the number of TFTs currently used in LCD products having a large pixel size, for example, 47-inch to 54-inch TVs, is approximately 6,000,000 to 7,000,000. This digital information display (DID) market requires an electronic paper display capable of realizing colors in a large area. When the active mode type as described with reference to the table 1 is employed to realize colors, a vast number of TFTs are needed, and thus, the module becomes bulkier.

Furthermore, even driving of a moving image may be required after scaling to large-area and colorizing are realized in the digital information display (DID) market. However, when the display is manufactured to have a large area, the number of TFTs is increased, and thereby, affecting a bad influence on driving of the display.

Therefore, development of the color realization type capable of meeting the current market standards for electronic paper display having a large area of 22 inches or more is urgently needed.

### SUMMARY OF THE INVENTION

An object of the present invention is to provide an electronic paper display capable of decreasing the number of TFTs to decrease the number of modules and reduce the volume in embodying a large-area electronic paper display.

Another object of the present invention is to provide a method for manufacturing the large-area electronic paper display.

According to an exemplary embodiment of the present invention, there is provided an electronic paper display, including: red, green, blue, and black (RGBK) rotatable balls respectively included in a plurality of pixel spaces isolated by barrier ribs; and thin film transistors (TFTs) each connected to two or more rotatable balls having the same color, among the red, green, blue, and black (RGBK) rotatable balls, wherein the thin film transistors (TFTs) for respectively realizing red, green, blue, and black (RGBK) colors may constitute one unit pixel.

The two or more rotatable balls having the same color may be connected to one pixel electrode.

Each of the red, green, blue, and black (RGBK) rotatable balls may have a size of below 100 μm.

The red, green, blue, and black (RGBK) rotatable balls may be independently driven according to the respective colors.

The number of the thin film transistors (TFTs) for color driving of red, green, blue, and black (RGBK) may correspond to the number of colors included per unit pixel, regardless of the number of respective RGBK rotatable balls.

The rotatable balls having the same color, which are included in neighboring unit pixels, may be connected to one TFT.

The contrast of respective red, green, blue, and black (RGBK) colors, in each unit pixel, may be adjustable.

According to another exemplary embodiment of the present invention, there is provided a method for manufacturing an electronic paper display, the method including: injecting red, green, blue, and black (RGBK) rotatable balls into a plurality of pixel spaces isolated by barrier ribs; and connecting two or more rotatable balls having the same color, among the red, green, blue, and black (RGBK) rotatable balls, to one thin film transistor (TFT).

The connecting of the RGBK rotatable balls may be performed such that the rotatable balls having the same color are connected to a pixel electrode by using one thin film transistor (TFT).

### BRIEF DESCRIPTION OF THE DRAWINGS

FIGS. 1 and 2 are views showing respectively a structure and a color realization method of an electronic paper display according to the related art;

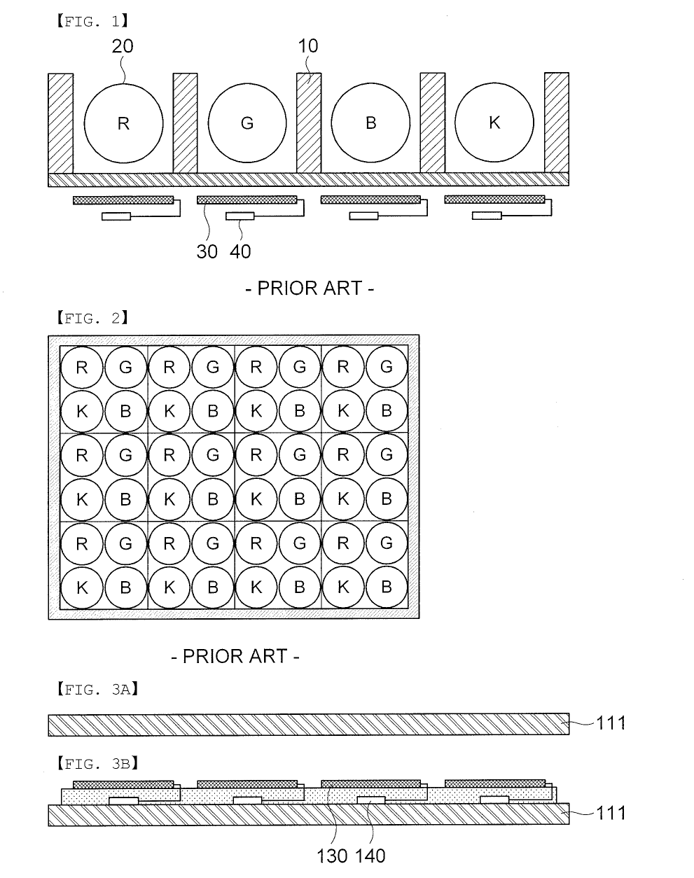

FIGS. 3A to 3F are views showing a process of manufacturing an electronic paper display according to an exemplary embodiment of the present invention;

FIGS. 4A to 4D are views showing arrangement configurations of RGBK rotatable balls in an electronic paper display according to an exemplary embodiment of the present invention;

FIG. 5 is a view showing a color realization method of an electronic paper display according to an exemplary embodiment of the present invention;

FIGS. 6A to 6G are views showing a process of manufacturing an electronic paper display according to another exemplary embodiment of the present invention;

FIGS. 7A to 7D are views showing arrangement configurations of RGBK rotatable balls in an electronic paper display according to another exemplary embodiment of the present invention; and

FIG. 8 is a view showing a color realization method of an electronic paper display according to another exemplary embodiment of the present invention.

### DESCRIPTION OF THE PREFERRED EMBODIMENTS

Hereinafter, preferred embodiments of the present invention will be described in detail with reference to the accompanying drawings.

Terms used in the specification are used to explain the embodiments and not to limit the present invention. In the specification, a singular type may also be used as a plural type unless stated specifically. “Comprises” and/or “comprising” used in the specification mentioned constituent members, steps, operations and/or elements but do not exclude the existence or addition of one or more other components, steps, operations and/or elements.

Further, in the drawings, the thickness of layers and regions may be exaggerated for efficient description of technical contents and consequently, exemplified forms may be changed by manufacturing technologies and/or tolerances. In the drawings, the same numeral is referred to the same component. Terms, “and/or” used in the specification, include, of the corresponding items listed, any one, or one or more combinations thereof.

The present invention relates to an electronic paper display capable of realizing various colors in a large area even with a module having a small volume, by using rotatable balls, and a method for manufacturing the same.

More specially, red, green, blue and black (hereafter, referred to as ‘RGBK’) rotatable balls are included in a plurality of pixel spaces isolated by barrier ribs. Two or more rotatable balls having the same color, among the RGBK rotatable balls, are connected to one thin film transistor (TFT), and the RGBK rotatable balls and thin film transistors respectively connected thereto constitute one unit pixel.

In the related art, four RGBK rotatable balls are included in the pixel spaces one by one, and respectively connected to four TFTs for driving of the respective colors, in order to constitute one unit pixel. This type allows a small-sized display to be embodied, but has a problem in actually embodying a large-area display due to difficulty in manufacturing a module caused by using too many TFTs.

On the contrary to this, in the present invention, two or more rotatable balls having the same color, among the RGBK rotatable balls, are connected to one TFT, and thereby to remarkably decrease the number of TFTs needed for actual color realization even when a large-area display is embodied. Here, the two or more rotatable balls having the same color connected to one TFT may be connected to one pixel electrode.

When a red color is taken as an example, two red rotatable balls, which are included in each of pixel spaces isolated from each other, are connected to one pixel electrode, and the pixel electrode is connected to one thin film transistor. This is equally applied to cases with respect to green, blue, and black rotatable balls different from the red rotatable ball.

Therefore, while the total number of RGBK rotatable balls is 8, the number of actually necessary TFTs is 4, and thus, the number of TFTs is decreased by half, in comparison with the related art. The pixel electrode may be also formed to lengthily connect two rotatable balls of each color in one. As such, since the number of TFTs needed is effectively decreased, a more advantageous effect can be obtained as the display has a larger area.

This is because the number of thin film transistors (TFTs) for RGBK color driving is adjusted to correspond to the number of colors per unit pixel, regardless of the number of respective RGBK rotatable balls.

Therefore, even though the number of respective RGBK rotatable balls is increased, the number of TFTs actually needed is significantly decreased.

Each of the RGBK rotatable balls used in the present invention, preferably, has a size of below 100 μm. In the present, in order to realize colors by using rotatable balls of 100 μm or more, a voltage of about 80V is needed. Therefore, when the size of the rotatable ball is decreased to below 100 gms, as in the present invention, color realization is possible even at a lower voltage in comparison with the related art, for example, 50V or less, preferably 10V to 40V, resulting in advantages in view of fast response speed and driving of the moving image at the time of active mode type driving.

In the electronic paper display of the present invention having the above structure, the RGBK rotatable balls are independently driven by the colors. Therefore, according to one exemplary embodiment of the present invention, the contrast of respective RGBK colors is adjustable in each unit pixel. In other words, two or more rotatable balls having the same color are connected to one TFT to strongly exhibit one color, but, at this time, when the other rotatable balls in the vicinity of the corresponding rotatable balls are weakly driven, the colors realized by the other rotatable balls are weaker than the original colors thereof.

For example, four rotatable balls exhibiting each of the RGBK colors may be connected to one TFT, and in this case, the total number of RGBK rotatable balls is 16 and the number of TFTs is 4, and these constitute one unit pixel. When the unit pixels having this structure are continuously arranged, respective colors can be independently realized according to the respective RGBK colors in each unit pixel.

This effectiveness cannot be achieved in the related art that realizes colors by connecting one rotatable ball to one TFT one by one. In addition, the above structure may be equally applied in rotatable balls having different colors, thereby realizing desired colors as well as adjusting even concentrations of respective RGBK colors.

In addition, according to an exemplary embodiment of the present invention, the rotatable balls having the same color included in neighboring unit pixels may be connected to one TFT. In other words, in a structure in which four rotatable balls exhibiting each of the RGBK colors may be lengthily connected to one pixel electrode and one TFT is connected thereto, the four rotatable balls exhibiting each of the RGBK colors are connected in also the neighboring unit pixel. Therefore, four red rotatable balls of a first unit pixel and four red rotatable balls of a second unit pixel neighboring the first unit pixel may be connected to one TFT. This may be equally applied in the other colors also.

Therefore, when the rotatable balls having the same color are continuously arranged, regardless of the number of RGBK rotatable balls connected to one TFT, the rotatable balls having the same color may be connected to the same TFT. In this structure, since, regardless of the number of RGBK rotatable balls, the TFTs corresponding to the number of colors are needed, the volume of the module can be reduced at the time of embodying a large-area display.

Hereafter, a method for manufacturing an electronic paper display according to the present invention will be described in detail.

A method for manufacturing an electronic paper display according to the present invention may include injecting RGKB rotatable balls into a plurality of pixel spaces isolated by barrier ribs, and connecting two or more of the rotatable balls having the same color to one thin film transistor.

Any one of barrier rib formation and TFT connection may be first performed. For example, a transparent electrode may be formed on an upper substrate, followed by forming barrier ribs, injecting the rotatable balls, and connecting to TFTs.

Also, the pixel electrodes and the TFTs may be formed on a lower substrate, followed by laminating the transparent electrode, forming the barrier ribs, and injecting the rotatable balls.

The important point is that two or more rotatable balls having the same color, among respective RGBK rotatable balls, are connected to pixel electrodes by using one TFT, and besides this, the process order between forming barrier ribs and connecting to TFTs is not largely limited.

An exemplary embodiment of the present invention will now be described in detail with reference to the accompanying drawings.

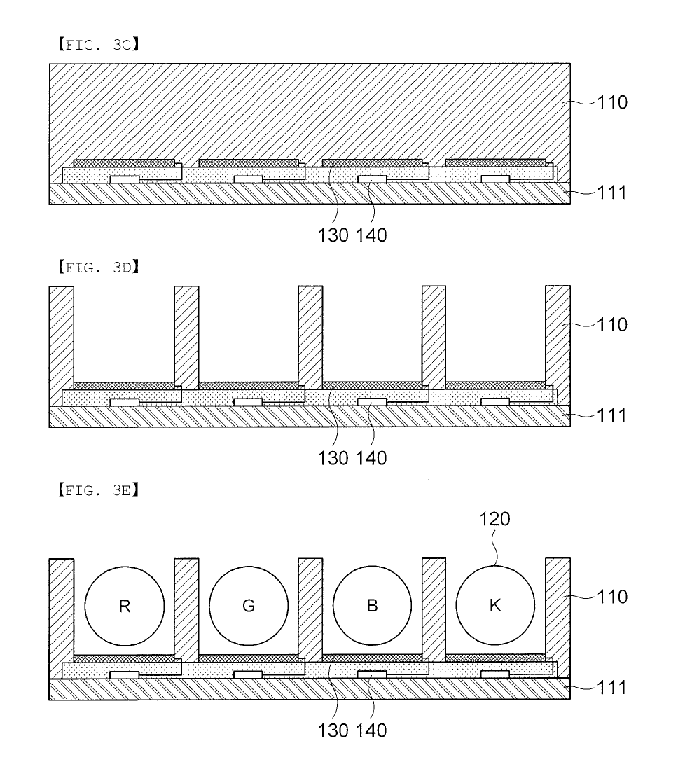

FIGS. 3A to 3F are views showing a process of manufacturing an electronic paper display according to an embodiment of the present invention. Referring to FIGS. 3A to 3F, a lower substrate 111 made of materials such as indium tin oxide (ITO) glass or polyethylene terephthalate is prepared. On the lower substrate 111, pixel electrodes 130 are electrically connected, and TFTs 140 are connected to the pixel electrodes 130. A transparent dry film resist (DFR) is laminated thereon to form a plurality of barrier ribs 110. A patterning process by using the DFR may be performed according to known methods, such as general coating, exposing, developing, and the like.

When pixel spaces are formed by the barrier ribs 110, respective RGBK rotatable balls 120 are injected into the respective pixel spaces. After the rotatable balls are injected into the respective pixel spaces, an upper substrate 113 made of the same materials as the lower substrate 111 are bonded to the upper substrate 113. The bonding of the lower substrate 111 and the upper substrate 113 is performed by using an insulation polymer such as epoxy resin. Here, a dam structure 114 is used to adjust the height of an adhesive surface of the epoxy resin so that the lower substrate 111 and the upper substrate 113 are bonded on only the desired portions thereof. Finally, oil is injected into respective pixel spaces.

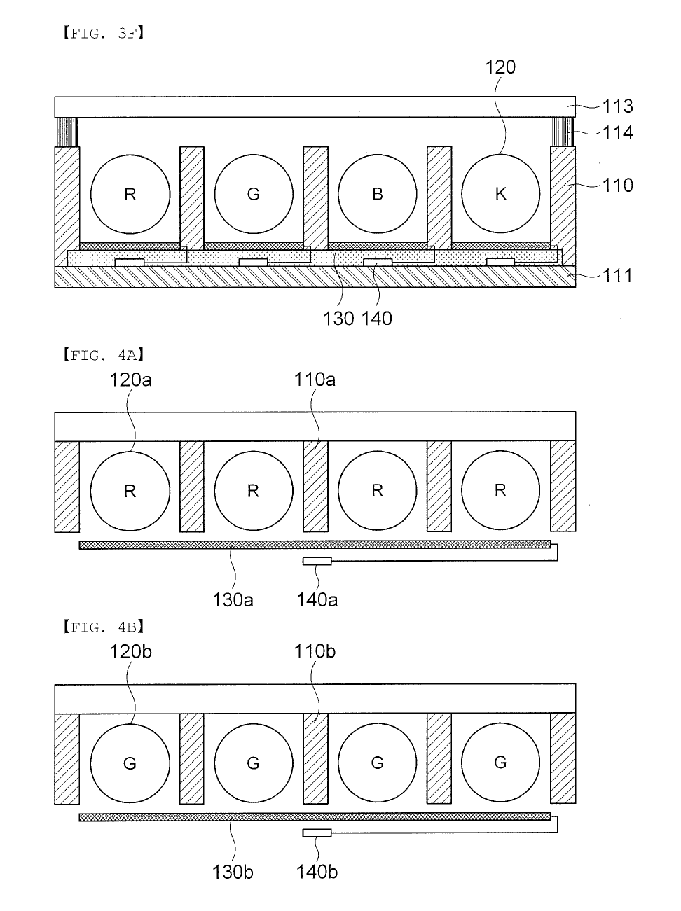

FIGS. 4A to 4D are views showing arrangement configurations of respective RGBK rotatable balls in the electronic paper display manufactured by the procedure described above. Four rotatable balls exhibiting each of RGBK are connected to each of pixel electrodes 130a, 130b, 130c, and 130d, which are again respectively connected to TFTs 140a, 140b, 140c, and 140d.

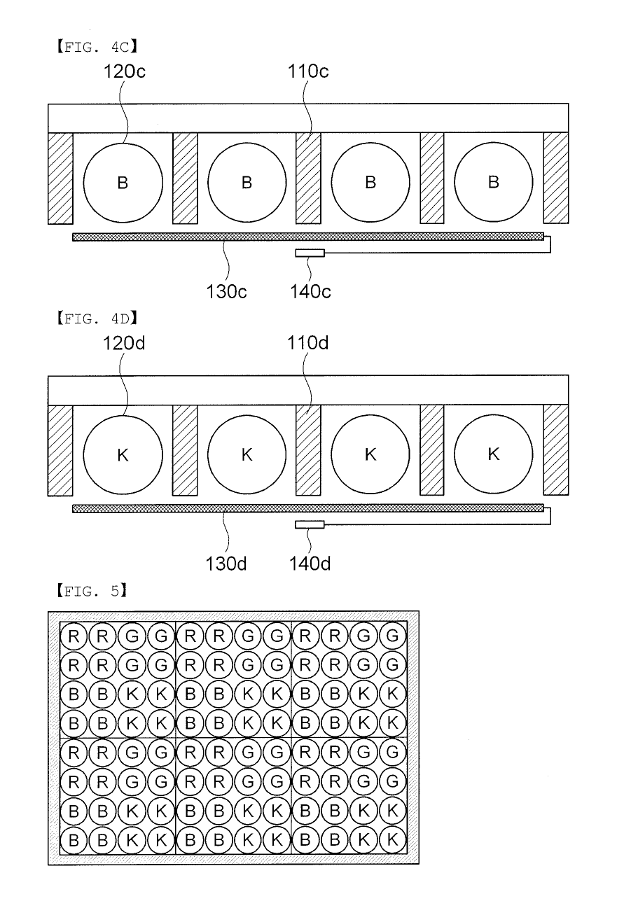

FIG. 5 is a schematic view showing a 22-inch display in which the above structure is embodied. Referring to FIG. 5, a total of 16 RGBK rotatable balls, of which every 4 rotatable balls by the colors of RGBK are connected to each other, are connected to 4 TFTs, and this constitutes one unit pixel. As in FIG. 5, since thin film transistors (TFTs) for driving each unit pixel are included in each unit pixel correspondingly to the number of colors per unit pixel, regardless of the number of RGBK rotatable balls included in each unit pixel, the volume of the module is effectively reduced at the time of embodying a large-area display.

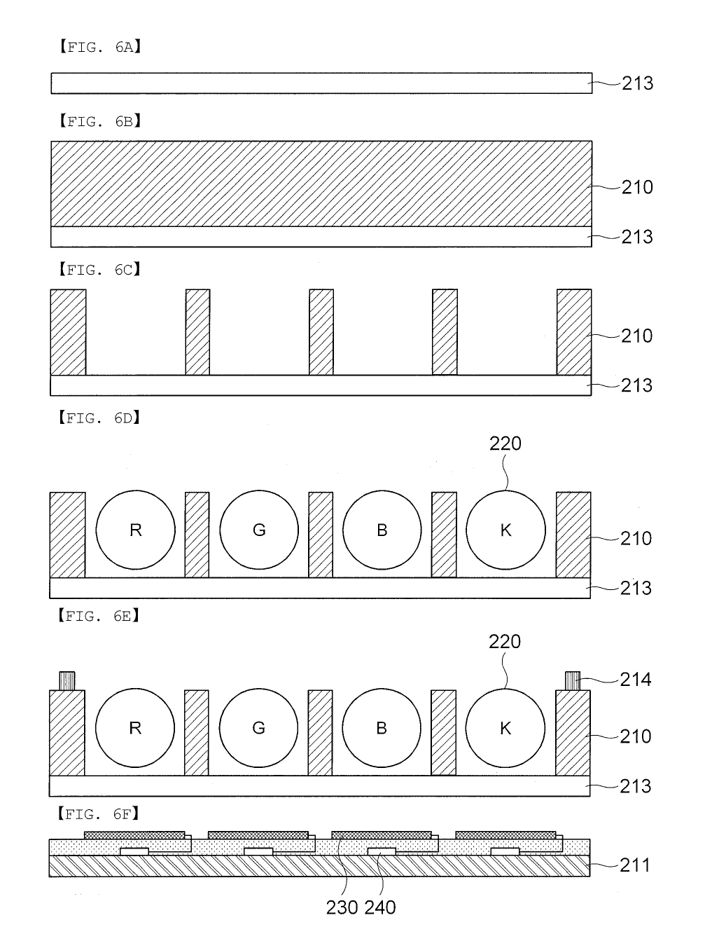

FIGS. 6A to 6G are views showing a process of manufacturing an electronic paper display according to an embodiment of the present invention. Referring to FIGS. 6A to 6G, an upper substrate 213 made of materials such as indium tin oxide (ITO) glass or polyethylene terephthalate is prepared. A transparent dry film resist (DFR) is laminated on the upper substrate 213 to form a plurality of barrier ribs 210. A patterning process by using the DFR may be performed according to known methods such as general coating, exposing, developing, and the like. When pixel spaces are formed by the barrier ribs 210, respective RGBK rotatable balls 220 are injected in the respective pixel spaces. In addition, a dam structure 214 may be formed for subsequent bonding between the upper substrate 213 and a lower substrate 211.

The lower substrate 211 to be bonded on the upper substrate 213 is prepared by connecting pixel electrodes 230 and TFTs 240. Then, the upper substrate 213 and the lower substrate 211 are bonded on each other, and here, a bonding aligner or the like may be used. In addition, finally, oil is injected into the respective pixel spaces.

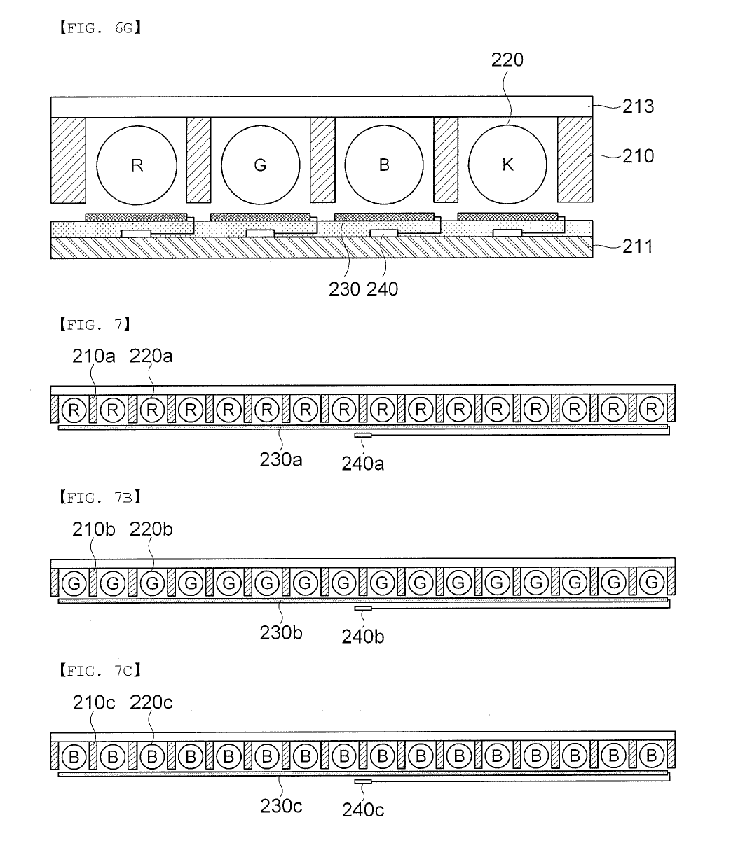

FIGS. 7A to 7D are views showing arrangement configurations of respective RGBK rotatable balls in the electronic paper display manufactured by the procedure described above. Sixteen rotatable balls included in respective pixel spaces for each color are connected to each of pixel electrodes 230a, 230b, 230c, and 230d, which are again connected to TFTs 240a, 240b, 240c, and 240d respectively.

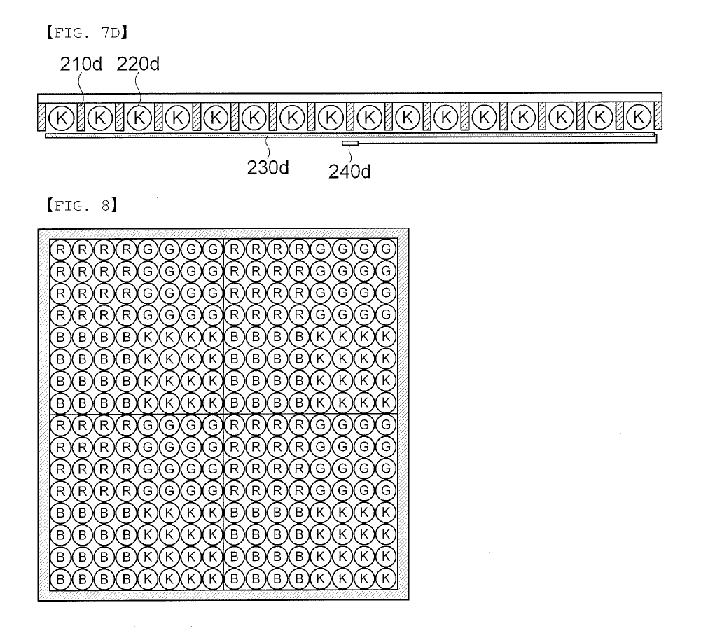

FIG. 8 is a schematic view showing a 40-inch or larger display in which the above structure is embodied. Referring to FIG. 8, a total of 64 RGBK rotatable balls, of which every 16 rotatable balls by the colors of RGBK are connected to each other, are connected to 4 TFTs, and this constitutes one unit pixel. As in FIG. 8, since thin film transistors (TFTs) for driving each unit pixel are included in each unit pixel correspondingly to the number of colors per unit pixel, regardless of the number of RGBK rotatable balls included in each unit pixel, the volume of the module is effectively reduced at the time of embodying a large-area display.

This may have a larger effect as the size of the display becomes larger. The volume of module may be expected to be effectively decreased in embodying a large-area display, in comparison with the related art in which respective RGBK rotatable balls, that is, a total of 4 RGBK rotatable balls for respectively exhibiting four colors and 4 TFTs are needed in one unit pixel. Therefore, many TFTs corresponding to the number of RGBK rotatable balls are not needed even in an electronic paper display having a large area of 22 inches or more, the module can be constituted to have a small volume.

The size of the rotatable ball included in the unit pixel of the present invention, is, preferably, decreased as the display has a larger area. This is why the size of pixel depends on the size of rotatable ball, and thus, the voltage for color driving is decreased. In other words, this may be, above all, preferable in color realization of a large-area display since the size of pixel becomes decreased as the size of rotatable ball becomes smaller in the same-sized display. The resolution may be somewhat decreased when the size of pixel is small, but a certain extent of decrease in resolution is not really a problem in a large-area display.

As set forth above, according to the exemplary embodiments of the present invention, when the rotatable balls exhibiting each of the RGBK colors are bound in two or more and simultaneously driven within one unit pixel, the pixel electrodes are made to be large and connected to one TFT. As a result, the number of TFTs can be decreased even though a large-area display is manufactured, and the volume of module can be minimized.

Further, at the time of driving the large-area display, two or more rotatable balls having the same color are included to control respective RGBK colors as well as the concentration thereof, resulting in realization of various colors.

Further, even though the size of rotatable ball is made small to a degree such that a large area is embodied and a moving picture is displayed, no loss is generated in view of coloring and driving.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims include another embodiment.

What is claimed is:

1. An electronic paper display, comprising:
red, green, blue, and black (RGBK) rotatable balls respectively included in a plurality of pixel spaces isolated by barrier ribs; and
thin film transistors (TFTs) each connected to two or more rotatable balls having the same color, among the red, green, blue, and black (RGBK) rotatable balls,
wherein the thin film transistors (TFTs) for respectively realizing red, green, blue, and black (RGBK) colors constitute one unit pixel.

2. The electronic paper display according to claim 1, wherein the two or more rotatable balls having the same color are connected to one pixel electrode.

3. The electronic paper display according to claim 1, wherein each of the red, green, blue, and black (RGBK) rotatable balls has a size of below 100 μm.

4. The electronic paper display according to claim 1, wherein the red, green, blue, and black (RGBK) rotatable balls are independently driven according to the respective colors.

5. The electronic paper display according to claim 1, wherein the number of the thin film transistors (TFTs) for color driving of red, green, blue, and black (RGBK) corresponds to the number of colors included per unit pixel, regardless of the number of respective RGBK rotatable balls.

6. The electronic paper display according to claim 1, wherein the rotatable balls having the same color, which are included in neighboring unit pixels, are connected to one TFT.

7. The electronic paper display according to claim 1, wherein the contrast of respective red, green, blue, and black (RGBK) colors, in each unit pixel, is adjustable.

8. A method for manufacturing an electronic paper display, the method comprising:
injecting red, green, blue, and black (RGBK) rotatable balls into a plurality of pixel spaces isolated by barrier ribs; and
connecting two or more rotatable balls having the same color, among the of the red, green, blue, and black (RGBK) rotatable balls, to one thin film transistor (TFT).

9. The method according to claim 8, wherein the connecting of the RGBK rotatable balls is performed such that the rotatable balls having the same color are connected to a pixel electrode by using one thin film transistor (TFT).
